(19) United States
(12) Patent Application Publication
(10) Pub. No.: US 2012/0285564 A1
(43) Pub. Date: Nov. 15, 2012

(54) DEVICE FOR DOSING PAINT COMPONENTS

(76) Inventor: Pentii Airaksinen, Oulu (FI)

(21) Appl. No.: 13/510,723

(22) PCT Filed: Nov. 19, 2010
(86) PCT No.: PCT/FI2010/050938

§ 371 Date: Jul. 30, 2012

(30) Foreign Application Priority Data
Nov. 20, 2009 (FI) 20096210

(51) Int. Cl. F17D 3/00

(52) U.S. Cl. 137/565.01

(57) ABSTRACT

The invention relates to a device for dosing paint components, the device comprising a container (1) for a material to be dosed, an outlet conduit (2) exiting and starting from the container, a pump (3) connected to the outlet conduit, a suction valve (40) arranged in the outlet conduit before the pump (3), a discharge valve (50) connected to the outlet conduit after the pump, and a dosing nozzle connected to the discharge valve, wherein during a suction stroke of the pump (3) the suction valve (40) is arranged to open and, correspondingly, during an exhaust stroke of the pump the discharge valve (50) is arranged to open, and wherein particularly both the suction valve and the discharge valve are forced-controlled and their closing direction is in a discharge direction of the material to be dosed.

### BACKGROUND OF THE INVENTION

The invention relates to a device for dosing paint components, the device comprising a container for a material to be dosed, an outlet conduit exiting and starting from the container, a pump connected to the outlet conduit, a suction valve arranged in the outlet conduit before the pump, a discharge valve connected to the outlet conduit after the pump, and a dosing nozzle connected to the discharge valve, wherein during a suction stroke of the pump the suction valve is arranged to open and, correspondingly, during an exhaust stroke of the pump the discharge valve is arranged to open.

In dosing paint components, gear pumps, piston pumps as well as various membrane or bellows pumps have been used. In connection with membrane and bellows pumps, flow-controlled automated return valves have been used owing to their superior simplicity and inexpensiveness. Return valves, on the other hand, have become known particularly in compressible material pumping, such as pneumatics. In liquids dosing, return valves are challenging because at least two such valves have to be arranged successively in a flow direction. Being basically almost incompressible, the liquid remaining between such successive valves tends to prevent proper closure of a valve which in the flow direction resides on the outlet side. This phenomenon is emphasized when, owing to reasons of dosing accuracy, the aim is to minimize the volume of the pump and the valves.

When a medium to be dosed contains separate particles, such as pigment, dehydrated binders or fragments originating from grinding, they easily become stuck within the return valve, causing dripping or actual uncontrolled leakage of the liquid. Attempts have sometimes been made to eliminate this phenomenon by arranging additional return valves successively in series. Particles have then collected onto the sealing surfaces of the valves even more intensively, making the leakage disastrously disturbing. The reason for the particles becoming stuck onto the sealing surfaces of the valves in particular is that the valve, upon closing against the aforementioned liquid column, forms in the closing gap a self-acting filter onto which the particles become stuck into the ever-narrowing gap. Attempts have been made to eliminate this tendency by making one sealing surface sharp and by increasing the closing force in the hope of the forming “sealing knife” cutting the particles in two. In practice, however, this is not the case but the particles submerge into the other elastic surface and become permanently stuck therein. This causes a continuous leakage in the system on account of the hydrostatic pressure caused by a difference between the liquid surfaces. This, in turn, makes the dosing devices useless, causing large economical losses, dangerous situations, and property damage because of the staining pigments.

The phenomenon is emphasized by the fact that a spring is usually used for closing the valves, or a moving part of a valve in itself forms a spring. In such a case, a common spring operating in accordance with Hooke's law is particularly disadvantageous since the spring force increases as the flow increases and decreases as the moving part of the valve approaches a sealing position. Consequently, such a valve operates in a backwards manner by raising, as the flow increases, the pumping pressure considerably, the force necessary for sealing nevertheless remaining disproportionately small. The suction valve in particular is critical because its spring can produce no force larger than the necessary underpressure since otherwise the valve does not open at all. The overall situation is disadvantageous particularly in dosing colour pastes, wherein the aim is to keep the liquid in a small volume, uncompressed, and the liquid always contains particles.

All valve leakages, irrespective of their direction either into the exterior world or back into the container during pumping, are inadmissible failures that affect the dosing accuracy.

### SUMMARY OF THE INVENTION

An object of the invention is thus to eliminate the above-described problems and to provide a solution which effectively prevents a flow and a leakage also after pumping is completed. This object is achieved by a device according to the invention, which is mainly characterized in that both the suction valve and the discharge valve are forced-controlled and their closing direction is in a discharge direction of the material to be dosed.

This enables an absolutely reliable dosing closure to be achieved, wherein leakage of the material to be dosed from the dosing nozzle is almost impossible.

When, in addition, the valves are spring-loaded in a discharge direction of the material to be dosed and thus at the same time in a closing direction of the valves, after dosing they are closed automatically with no forced control. Consequently, forced control is then necessary only for opening the valves.

In the solution according to the invention, the essential point is that also when the device is inactive, and owing to the pressure prevailing therewithin, caused by the material to be dosed, the last valve, i.e. the discharge valve, tightens to a closing position, as does the suction valve which also tightens to the closing position on account of the hydrostatic pressure prevailing in the container. This enables two valves to be connected in series so as to prevent leakage. Even if one of the valves starts slightly leaking over time, both valves are highly unlikely to leak at the same time. The same arrangement also enables the suction valve to serve as a return valve with respect to the pump when it is not under forced control. If the discharge valve or the nozzle suffers from damage or clogging, the pump remains intact since the suction valve may operate as a pressure restricting valve against the spring, ensuring the operation of the device. Thus, no mechanical damage owing to unproportional pressure increase can occur in the device.

In an appropriate manner, the forced control of both valves is implemented independently of one another. The control may be implemented as servo control, wherein the opening degree of the valves is freely selectable.

The valves per se may be ball, disc, conical or any appropriate valves. The suction and discharge valves do not necessarily have to be of the same type, either.

The outlet conduit may be a tubular line to which the components of the dosing device are connected, or these components may be connected to one another directly, without any tube or wire structures therebetween. In the latter case, the structure may be such that a side of the pump including a head of a piston is provided with a valve space in close connection with the container via a suction port between the container and the valve space, whereby the outlet conduit between the container and the suction valve is formed by this suction port, and the suction valve is in close cooperation with the container via the suction port.

The solution according to the invention also enables an extremely preferred embodiment of the invention wherein the discharge valve also forms a dosing nozzle. This makes it possible that when the discharge valve closes, also the dosing nozzle closes, whereby no material to be dosed that could dry up in the nozzle remains therein. In the previous devices this caused problems, making stoppers, wipers, wetting devices or the like necessary for the nozzle. When the discharge valve and the nozzle constitute a single structure, no need for these exists. Thus, when no nozzle pipe actually exists, it is possible to achieve as accurate a dosing as possible, since no air bubbles, yields, deposits or dehydrated pastes to cause dosing errors can now exist after the nozzle any longer.

When the discharge valve at the end of the outlet conduit forms a nozzle-like projection, a protruding tip of the valve may be provided with a stud, and the valve may be opened simply by pressing this stud, if the dosing tip formed in this manner has dried up and starts causing dosing errors. This requires no expert service personnel but a user of the device may do it him/herself.

In the case of a combination of a discharge valve and a dosing nozzle, no drying-up should in practice occur since the valve/nozzle configuration becomes flushed whenever dosing is carried out. This also guarantees that the need to service and maintain the device is reduced and problems owing to the dehydration of pastes are alleviated, irrespective of the fact that the current pastes dry up very easily and require a lot of service and maintenance work in connection with other machines.

Further, in the case of a combination of a discharge valve and a dosing nozzle, its dosing movements may be arranged to be relative and continuous such that with small doses, when small parts of droplets are needed, the dosing port may be adjusted to a very small size. If this is not possible, the capillary forces of paste cause huge errors and inaccuracies in the dosing. Speed, on the other hand, may be generated by opening the discharge valve completely. This is usually necessary in connection with large paint pots, when accuracy is not dependent on the size of the droplets. In the existing machines, it has been difficult to achieve a successful compromise between speed and accuracy. All known devices are provided with a fixed dosing nozzle which dictates the speed and accuracy of the device.

### LIST OF FIGURES

The invention is now described in closer detail with reference to the accompanying drawings, in which

FIG. 1 is a schematic view showing a prior art device for dosing paint components;

FIG. 2 is a schematic view showing a device according to the invention for dosing paint components;

FIG. 3 is a schematic view showing another device according to the invention for dosing paint components;

FIGS. 4 to 6 show operation of a preferred discharge valve of a device according to the invention in different positions thereof; and

FIGS. 7 and 8 show sealing of a preferred discharge valve of a device according to the invention.

### DETAILED DESCRIPTION OF THE INVENTION

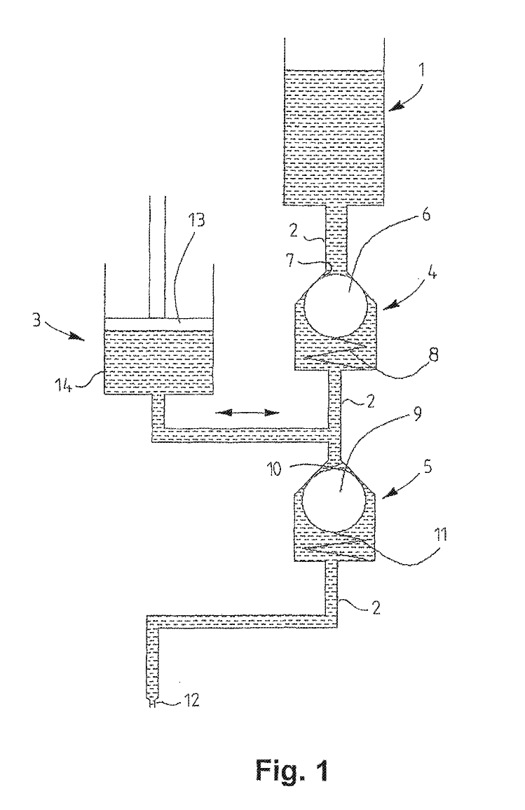

FIG. 1 shows a prior art device for dosing paint components, the device comprising a container 1 for a material to be dosed, an outlet pipe 2 exiting from the container 1, a pump 3 connected to the outlet pipe 2, a suction valve 4 connected to the outlet pipe 2 before the pump 3, a discharge valve 5 connected to the outlet pipe 2 after the pump 3, whereby underpressure and flow of a suction stroke of the pump 3 are arranged to open the suction valve 4, and pressure and flow of an exhaustion stroke of the pump are arranged to open the discharge valve 5. The pump 3 may be any pump having suction and exhaustion phases. An actuator (not shown) to drive the pump 3 is connected thereto. A part of the outlet conduit which connects to the discharge valve 5 and forms a dosing nozzle is designated by reference number 12. In order for a spherical closing part 6 of the suction valve 4 to become pressed against a seating surface 7 of the outlet conduit 2, thus closing the valve, a spring 8 which acts against a flow of the material to be dosed and presses the closing part 6 against the seating surface 7 is arranged after the closing part 6. Similarly, a spring 11 which acts in the same direction as the spring 8 and presses a closing part 9 of the discharge valve 5 against a seat 10 of the outlet conduit 2 is arranged after the closing part 9 of the discharge valve 5. Here, in addition to their suction and discharge functions, the valves 4 and 5 simultaneously serve as return valves.

When a prior art device according to FIG. 1 is used, first, a piston 13 of the pump 3 ascends in a cylinder 14 of the pump 3, thus causing an underpressure in the valves 4 and 5. Consequently, the discharge valve 5 remains closed, but the underpressure is capable of overcoming the force of the spring 8 of the suction valve 4, whereby the closing part 6 comes off from the seating surface 7 and the material to be dosed is allowed to flow from the container 1 past these, into the rear of the piston 13. When the effective direction of the piston 13 is reversed and it starts to descend in the cylinder 14, the piston 13 presses the material to be dosed contained in the cylinder 14, whereby the pressure towards the valves 4 and 5 increases. Now the suction valve 4 remains closed but the discharge valve 5 opens, since the pressure of the material to be dosed increases the pressure so that it overcomes the force produced by the spring 11. The material to be dosed is then allowed to flow past the closing part 9 of the valve 5 and further therefrom to the dosing nozzle 12.

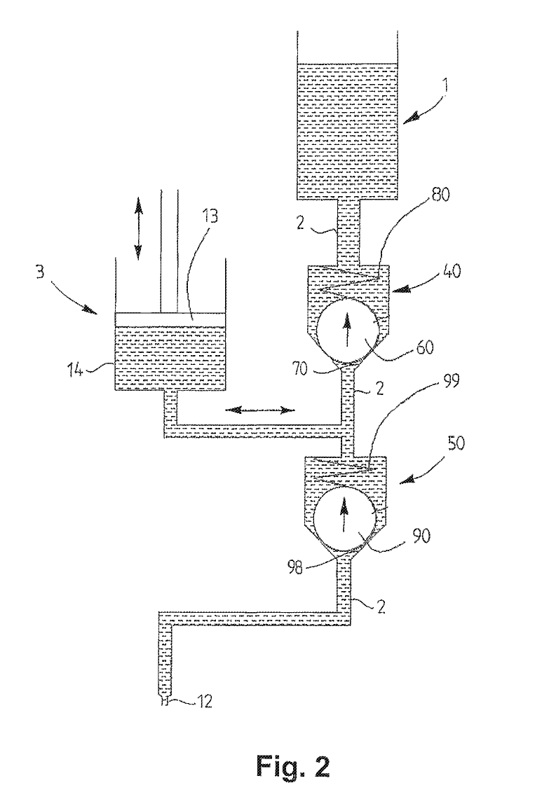

A solution according to the invention shown in FIG. 2 differs from the above-described known solution in a critical manner in terms of its suction and discharge valves 40 and 50. Otherwise the structure (the container 1, the outlet conduit 2, the piston 3, the dosing nozzle) corresponds with that shown in FIG. 1. Herein, the valves 40 and 50 are force-controlled and their closing direction is in a discharge direction of the material to be dosed. The valves 40 and 50 are thus like reversed valves in the structure according to FIG. 1. In such a case, forced control here means that they have to be opened by a suitable separate actuator (not shown) against the flow direction of the material to be dosed and, at the same time, against the closing force of springs 80 and 110 acting in the flow direction of the material to be dosed.

Thus, when using the device according to FIG. 2 and, similarly, according to the invention, first, the piston 13 of the pump 3 ascends in its cylinder 14, whereby the force of a spring 99 of a discharge valve 50 overcomes the formed underpressure, keeping a closing part 90 of the discharge valve 50 in place against a seat 98 and thus the discharge valve 50 closed. Simultaneously, the suction valve 40 is force-controlled to open, i.e. to move against the flow direction of the material to be dosed, in which case its closing part 60 comes off from a seating surface 70, overcoming the force of the spring 80, so that the material to be dosed is allowed to flow past the closing part 70, into the rear of the piston 13. When the effective direction of the piston 13 is reversed and the forced control of the suction valve is released, the piston 13 starts to descend in the cylinder 14 and the suction valve 40 remains closed by means of the spring 80. At the same time, the forced control is now directed to open the discharge valve 50 against the flow direction of the material to be dosed, so that its closing part 90 comes off from the seating surface 98, against the force of the spring 99, whereby the material to be dosed is allowed to flow past the closing part 90 and further therefrom to the dosing nozzle 12.

In the device according to the invention just described above, another essential point is that the suction valve 40, when not under forced control, acts like an ordinary return valve, so that when the dosing nozzle 4 is clogged, the pressure while the piston 13 of the pump 3 moves downwards can only increase in the system by an amount not exceeding that of the force of the spring 80 acting on the suction valve 40. In such a case, the suction valve 40 serves as a safety valve of the system. Normally, no such safety valves have been included in the dosing devices, which has caused serious damages during use if the dosing nozzle has become clogged. In order to prevent these damages, the device according to the invention is protected effectively. When, in addition, the control of the valves 40 and 50 is independent of one another, the timing of the valves 40 and 50 enables new possibilities for implementing accurate and reliable dosing.

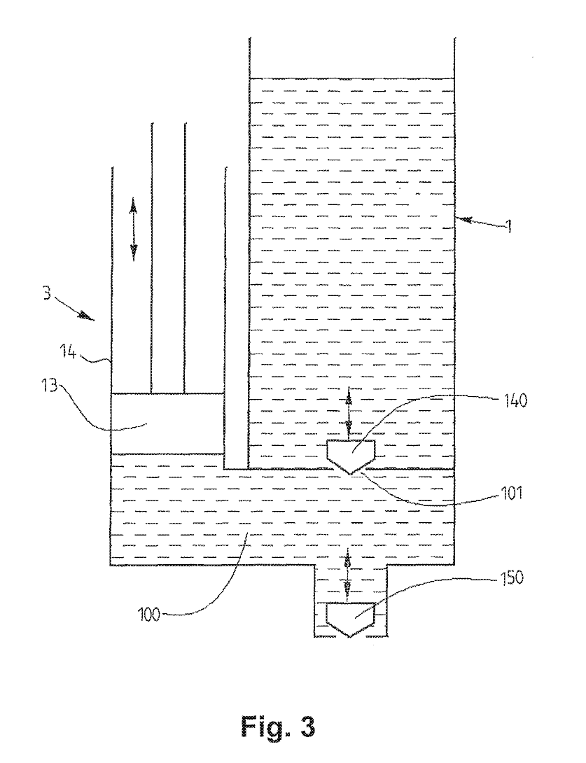

FIG. 3 shows a simplified version of a dosing device according to the invention. Therein, a side of the pump 3 having a piston head is provided with a valve space 100 in direct connection to the container 1 via a suction port 101 between the container 1 and the valve space 100, whereby an outlet conduit between the container 1 and a suction valve 140 is formed by the suction port 101. The suction valve 140 is in cooperation with the suction port 101 substantially inside the container 1. Similarly, a discharge valve 150 resides substantially inside the valve space 100. The valves 140 and 150 have functions corresponding with those of the valves according to FIG. 2, and they are subjected to a spring effect (not shown) similar to that set forth above. Herein, additionally, the discharge valve 150 also forms a dosing nozzle.

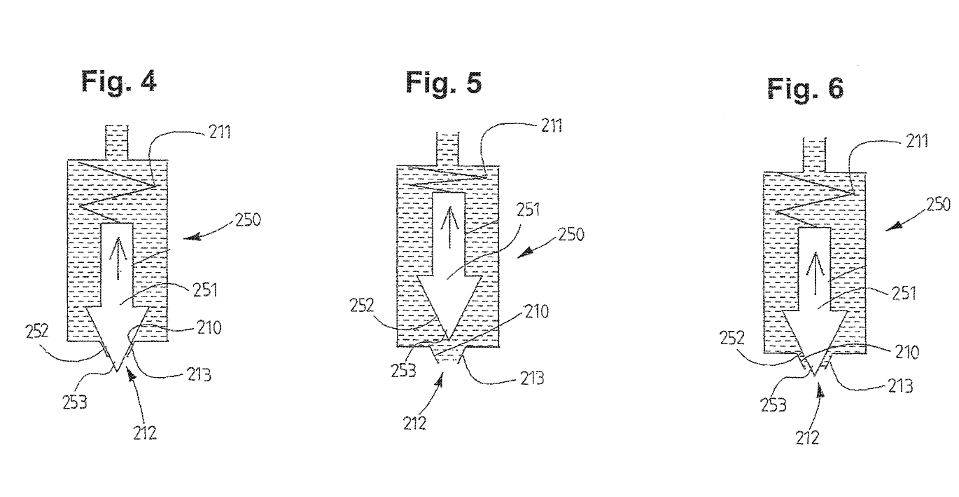

FIGS. 4 to 6 show a discharge valve 250 according to the invention, wherein a closing surface 252 of its closing part 251 and a mating surface 210 thereof in the outlet conduit are similar in shape and form a nozzle-like projection 212 which serves as a dosing nozzle.

In FIG. 4, the valve 250 is in a situation wherein the dosing nozzle 212 has been closed by a spring 211. The valve 250 may be opened in a forced-controlled manner, whereby the closing surface 252 is lifted off from the mating surface 210.

FIG. 5 shows the valve 250 completely open, whereby the material to be dosed is allowed to flow at full rate through the nozzle 212.

FIG. 6 shows a situation wherein an extremely accurate and small dosing amount is being dosed. In such a case, the closing part 251 of the valve 250 resides partly inside outer edges 213 of the nozzle projection 212, whereby the closing surface 252 of the closing part 251 and the mating part 210 thereof in the nozzle projection 212 are located very close to one another. This enables the material to be dosed to be dosed from an extremely small annular gap, so that capillary forces ensure that it is possible to detach a very small droplet. At the same time, the mating surface 210 and a tip 253 of the closing part 251 serve as control for a spray and a droplet so that all flow, if the nozzle 250 is only partially open, passes the closing part 251, flushing the surfaces 252 and 210 efficiently, and a possible small droplet remains hanging from the tip 253. This is advantageous in that the size of the droplet can be controlled. The valve 250 cleanses itself and accurately doses also small doses that in previous valve and nozzle structures have been difficult to implement. If the movement of the closing part 251 is even made servo-driven, all situations shown in FIGS. 4 to 6 may be used. The closing part 251 of the valve 250 may thus be adjusted as necessary to any position by adjusting its movement by servo control.

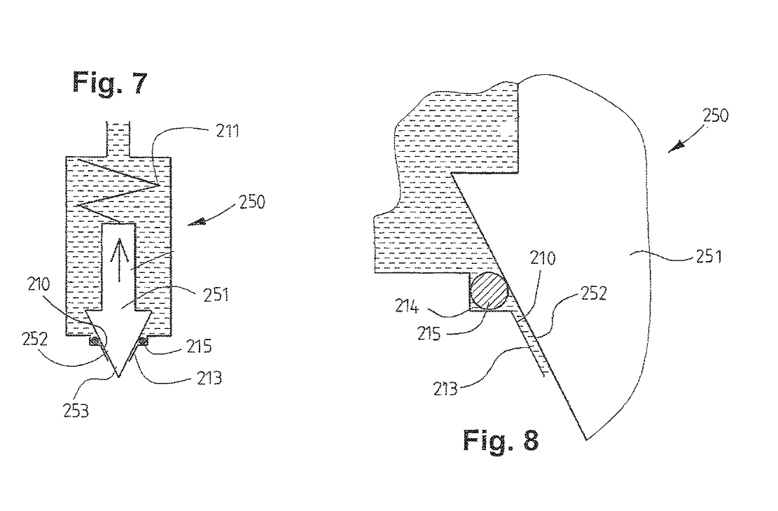

FIGS. 7 and 8 show an addition to the discharge valve 250 shown in FIGS. 4 to 6. Therein, a seal 215 is arranged between the closing surface 252 of the closing part 251 of the discharge valve 250 and the corresponding mating surface 210 of the outlet conduit, in an annular groove 214 provided at the beginning of the mating surface 210, on a side of an inlet flow of the material to be dosed. This location of the seal 215 is essential since here it is always in contact with the material to be dosed, prevented from drying up even if the material beneath it dried up. Even if the gap located beneath the seal and filled up with the material to be dosed did dry up, this is not harmful because the drying is confined to the film-like surface whose evaporating surface is insignificant compared with its length. Since the narrow gap makes evaporation from the film extremely slow, it is in practice impossible for a lower part of the closing surface 252 and the seal 215 to dry up. And when the valve 250 is used the next time, a possible dried-up liquid film between the surfaces 251 and 210 is flushed away and causes no clogging of the valve 250. Naturally, a suction valve may also be provided with a necessary separate seal, like the discharge valve.

In this manner, the discharge valve 250 and the dosing nozzle formed thereby may be simultaneously provided with an automatic closing means by the same movement as that used for closing the valve 250 itself. This is highly advantageous since previously, similar procedures had to be carried out by means of an exterior flap or a corresponding arrangement at the tip of the nozzle. This makes the overall operation of the nozzle unreliable and nevertheless may cause clogging of the nozzle. In the solution according to the invention, no wetting of the nozzles, a technique employed in some prior art devices, is necessary, either.

The above description of the invention is only meant to illustrate the basic idea according to the invention. Thus, a person skilled in the art may vary its details within the scope of the accompanying claims.

1-12. (canceled)

13. A device for dosing paint components, the device comprising:
a container for a material to be dosed,
an outlet conduit exiting and starting from the container,
a pump connected to the outlet conduit,
a suction valve arranged in the outlet conduit before the pump,
a discharge valve connected to the outlet conduit after the pump, and
a dosing nozzle connected to the discharge valve;
wherein:
during a suction stroke of the pump the suction valve is arranged to open and, correspondingly, during an exhaust stroke of the pump the discharge valve is arranged to open;
both the suction valve and the discharge valve are forced-controlled and their closing direction is in a discharge direction of the material to be dosed; and
the valves are spring-loaded in the discharge direction of the material to be dosed and at the same time in the closing direction thereof.

14. A device as claimed in claim 13, wherein the outlet conduit comprises a tubular line wherein the valves, the pump, and the dosing nozzle reside.

15. A device as claimed in claim 13, wherein a side of the pump including a head of a piston is provided with a valve space in close connection with the container via a suction port between the container and the valve space, such that the outlet conduit between the container and the suction valve is formed by the suction port, and such that the suction valve is in cooperation with the container via the suction port.

16. A device as claimed in claim 15, wherein the discharge valve resides substantially in the valve space.

17. A device as claimed in claim 13, wherein the valves each comprise at least one of a ball valve, a disc valve, and a conical valve.

18. A device as claimed in claim 13, where forced control of the valves is implemented independently of one another.

19. A device as claimed in claim 13, wherein forced control of the valves is implemented only in their opening direction.

20. A device as claimed in claim 13, wherein the discharge valve also forms a dosing nozzle.

21. A device as claimed in claim 20, wherein a closing surface of the discharge valve and its mating surface in the outlet conduit are similar in shape and form a nozzle-like projection.

22. A device as claimed in claim 21, wherein a seal is provided between the closing surface of the discharge valve and the corresponding mating surface of the outlet conduit, at the beginning of the projection formed thereby and on a side of an input flow of the material to be dosed.

23. A device as claimed in claim 22, wherein the seal is arranged in the mating surface of the outlet conduit.

24. A device as claimed in claim 13, wherein the valves are servo-controlled.
